(19) United States
(12) Patent Application Publication
(10) Pub. No.: US 2026/0233788 A1
(43) Pub. Date: Aug. 13, 2026

(54) SWING OUT SUPPORT FOR TAILGATE BED EXTENSION PANEL

(71) Applicants: Hyundai Motor Company, Seoul (KR); Kia Corporation, Seoul (KR)

(72) Inventors: Peter Scott, Superior Township, MI (US); Kihyun Cho, Hwaseong, (KR); Robert Gibbs, Superior Township, MI (US)

(21) Appl. No.: 19/048,243

(22) Filed: Feb. 7, 2025

(51) Int. Cl. B62D 33/08; B62D 33/027

(52) U.S. Cl. CPC B62D 33/08; B62D 33/0273

(57) ABSTRACT

A tailgate extension system and methods of use are provided. The tailgate extension system may comprise a tailgate coupled to a vehicle. The tailgate may comprise a frame, a panel hinge assembly coupled to the frame, a tailgate bed extension panel, coupled to the panel hinge assembly, and configured to rotate about the panel hinge assembly along a first axis of rotation, and a support arm coupled to the frame and configured to rotate about the frame along a second axis of rotation. The tailgate bed extension panel may be configured to rotate between a closed position and an open position. The support arm may be configured to rotate between a closed position and an open position. When the tailgate bed extension panel is in the open position and the support arm is in the open position, the tailgate bed extension panel may be configured to engage the support arm.

### BACKGROUND

### Technical Field

Embodiments of the present disclosure relate to swing out supports for tailgate bed extension panels and methods of use.

### Background

Pickup trucks generally have a tailgate which can be opened and closed along a singular axis. This enables access to the truck bed. Some pickup trucks have a tailgate which is configured to be opened along a plurality of axes. However, in tailgates that open along axes in such a way as to create a new loading surface, new loading supports such as support cables or similar devices are needed to support the new loading surface. The positioning of these supports obstructs access to the truck bed.

For at least these reasons tailgate supports for new loading surfaces of tailgates are needed which to not obstruct access to the truck bed.

### SUMMARY

According to an object of the present disclosure, a tailgate extension system is provided. The tailgate extension system may comprise a tailgate coupled to a vehicle. The tailgate may comprise a frame, a panel hinge assembly coupled to the frame, a tailgate bed extension panel, coupled to the panel hinge assembly, and configured to rotate about the panel hinge assembly along a first axis of rotation, and a support arm coupled to the frame and configured to rotate about the frame along a second axis of rotation. The tailgate bed extension panel may be configured to rotate between a closed position and an open position. The support arm may be configured to rotate between a closed position and an open position. When the tailgate bed extension panel is in the open position and the support arm is in the open position, the tailgate bed extension panel may be configured to engage the support arm.

According to an exemplary embodiment, the support arm may comprise an inner support arm and an outer support arm.

According to an exemplary embodiment, the support arm may be configured to extend into an extended position.

According to an exemplary embodiment, the tailgate extension system may comprise a retention mechanism configured to secure the support arm in the closed position.

According to an exemplary embodiment, the retention mechanism may comprise a retention pin and spring.

According to an exemplary embodiment, the frame may comprise an F-frame.

According to an exemplary embodiment, the tailgate extension system may comprise a striker coupled to the tailgate bed extension panel and a latch assembly coupled to the support arm.

According to an exemplary embodiment, when the tailgate bed extension panel engages the support arm, the striker may be configured to engage the latch assembly.

According to an exemplary embodiment, the frame may comprise an opening configured to house the support arm when the support arm is in the closed position.

According to an exemplary embodiment, the first axis of rotation may be perpendicular to the second axis of rotation.

According to an exemplary embodiment, the support arm may be configured to rotate 90 degrees about the frame to rotate from the closed position to the open position.

According to an exemplary embodiment, the tailgate extension system may comprise the vehicle.

According to an exemplary embodiment, the vehicle may comprise a pickup truck.

According to an object of the present disclosure, a method for engaging a tailgate panel extension bed support arm is provided. The method may comprise disengaging a retention mechanism. When engaged, the retention mechanism may be configured to secured a support arm of a tailgate in a closed position. The tailgate may be coupled to a vehicle and may comprise a frame, a panel hinge assembly coupled to the frame, a tailgate bed extension panel, coupled to the panel hinge assembly, and configured to rotate about the panel hinge assembly along a first axis of rotation, and, the support arm coupled to the frame and configured to rotate about the frame along a second axis of rotation. The tailgate bed extension panel may be configured to rotate between a closed position and an open position. The support arm may be configured to rotate between a closed position and an open position. When the tailgate bed extension panel is in the open position and the support arm is in the open position, the tailgate bed extension panel may be configured to engage the support arm. The method may comprise rotating the support arm into the open position and rotating the tailgate bed extension panel to an open position, causing the tailgate bed extension panel to engage the support arm.

According to an exemplary embodiment, the method may comprise, prior to rotating the support arm into the open position, rotating the hinge assembly, exposing the support arm.

According to an exemplary embodiment, the method may comprise extending the support arm into an open position.

According to an exemplary embodiment, the retention mechanism may comprise a retention pin and spring.

According to an exemplary embodiment, the tailgate may comprise a striker coupled to the tailgate bed extension panel and a latch assembly coupled to the support arm.

According to an exemplary embodiment, the method may comprise, when the tailgate bed extension panel engages the support arm, engaging the striker with the latch assembly.

According to an exemplary embodiment, the rotating the support arm into the open position may comprise rotating the support arm 90 degrees about the frame.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1A illustrates a rear perspective view of a vehicle comprising a tailgate bed extension panel support arm in a closed position, according to an exemplary embodiment of the present disclosure.

FIG. 1B illustrates a rear perspective view of a vehicle comprising a tailgate bed extension panel support arm in an open position, according to an exemplary embodiment of the present disclosure.

FIG. 1C illustrates a rear perspective view of a vehicle comprising a tailgate bed extension panel support arm in an expanded position, according to an exemplary embodiment of the present disclosure,

FIG. 1D illustrates a rear perspective view of a vehicle comprising a tailgate bed extension panel support arm in an expanded position and the tailgate bed extension panel in an open position, according to an exemplary embodiment of the present disclosure.

FIG. 2 illustrates an exploded view of a tailgate, according to an exemplary embodiment of the present disclosure.

FIG. 3 illustrates a schematic view of a tailgate bed extension panel support arm in a closed position, according to an exemplary embodiment of the present disclosure.

FIGS. 4A-4B illustrates a schematic view of a retention pin and spring in a first position (FIG. 4A) and a second position (FIG. 4B), according to an exemplary embodiment of the present disclosure.

FIG. 5 illustrates a schematic view of a striker of a tailgate bed extension panel coupled to a latch assembly of a support arm, according to an exemplary embodiment of the present disclosure.

FIG. 6 illustrates a flowchart of a method for engaging a tailgate panel extension bed support arm is illustratively depicted, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

According to an exemplary embodiment, swing out supports for tailgate bed extension panels and methods of use are provided.

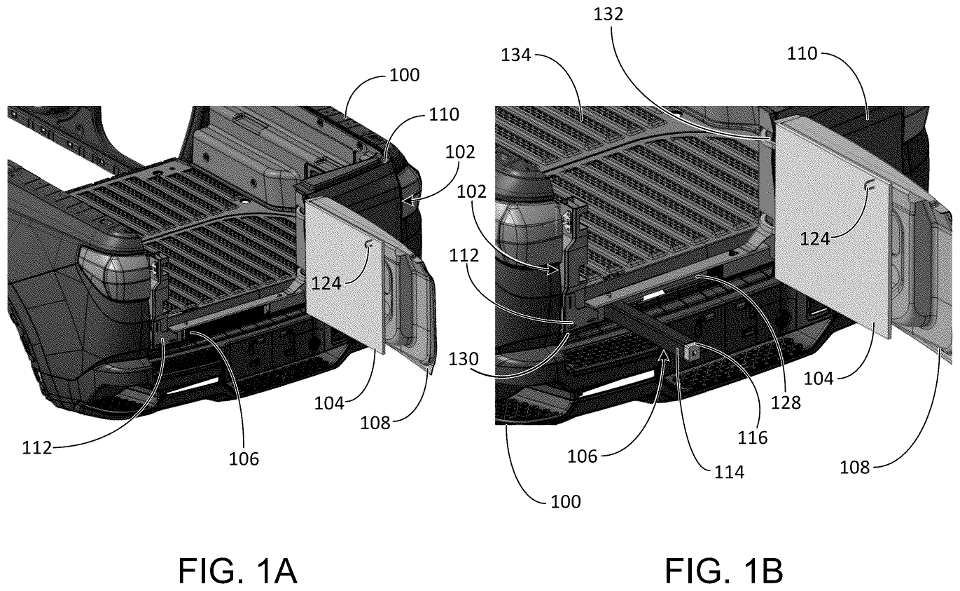

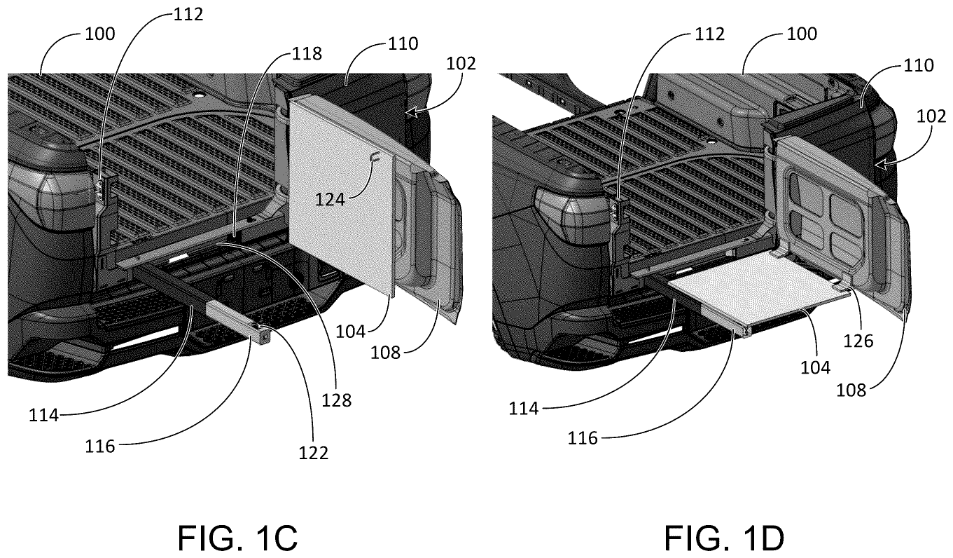

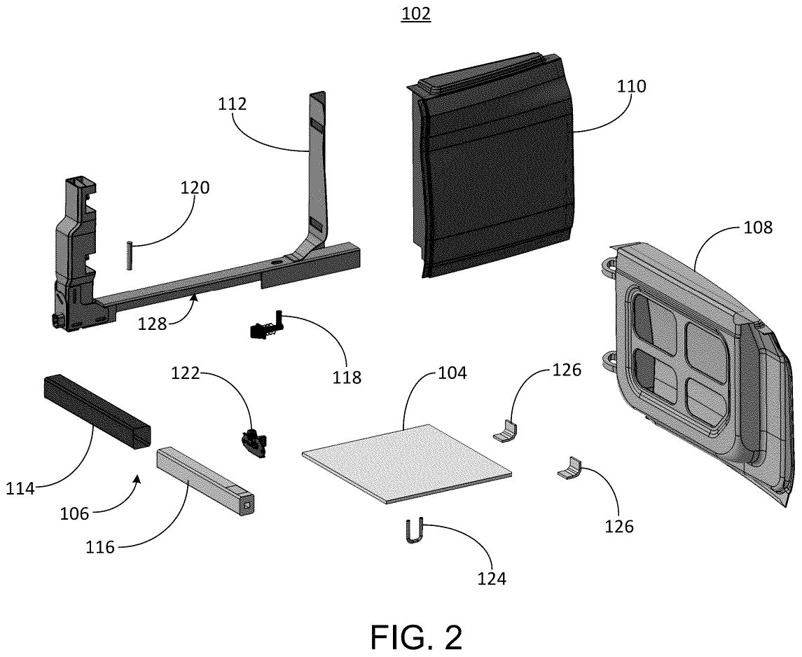

Referring now to FIGS. 1A-2, a rear perspective view of a vehicle 100 comprising a tailgate 102 comprising a tailgate bed extension panel 104 and a support arm 106 in a closed position (FIG. 1A), an open position (FIG. 1B), and an extended position (FIG. 1C) configured to support the tailgate bed extension panel 104 when the tailgate bed extension panel 104 is in an open position (FIG. 1D) are illustratively depicted, according to exemplary embodiments of the present disclosure. As shown in FIG. 2, an exploded view of the tailgate 102 is illustratively depicted, in accordance with an exemplary embodiment of the present disclosure.

According to an exemplary embodiment, the vehicle 100 may comprise a pickup truck or other suitable vehicle. According to an exemplary embodiment, the tailgate 102 may be configured to open along a plurality of axes 130, 132 to enable access to a bed 134 of the vehicle 100.

According to an exemplary embodiment, the tailgate 102 may comprise a left hand panel hinge assembly 108, a right hand panel assembly 110, an frame 112, an outer support arm 114 of the support arm 106, an inner support arm 116 of the support arm 106, a retention mechanism 118, a pivot axis pin 120, a latch assembly 122, the tailgate bed extension panel 104, a striker 124, one or more panel hinges 126, and/or other suitable components. While a left hand panel hinge assembly 108 and a right hand panel assembly 110 are shown, it is noted that, according to various exemplary embodiments, the hinge assembly 108 may comprise a left hand or right hand hinge assembly 108 and the panel assembly 110 may comprise a right hand or left hand panel assembly 110 while maintaining the spirit and functionality of the present disclosure. According to an exemplary embodiment, support arm 106 and/or the panel hinge assembly 108 may be coupled to the frame 112 and configured to rotate about the frame 112. According to an exemplary embodiment, the frame 112 may comprise an F-frame and/or other suitable frame. According to an exemplary embodiment, the tailgate bed extension panel 104 may be coupled to, and configured to rotate about, the panel hinge assembly 108. According to an exemplary embodiment, an axis of rotation of the tailgate bed extension panel 104 may be perpendicular to an axis of rotation of the support arm 106.

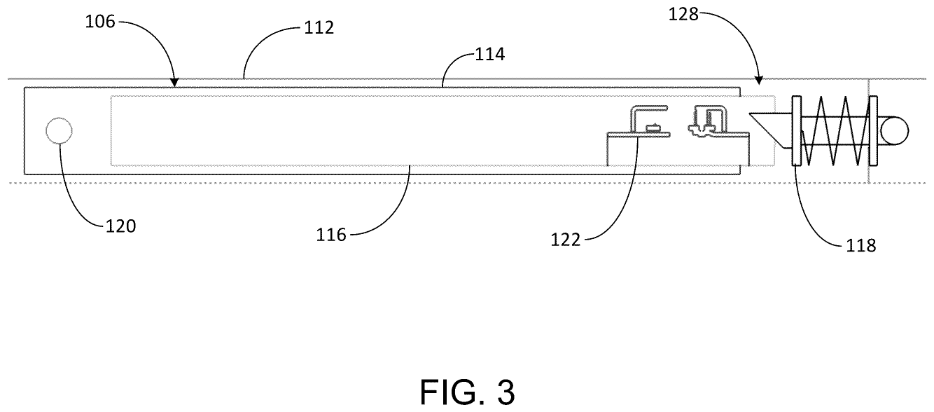

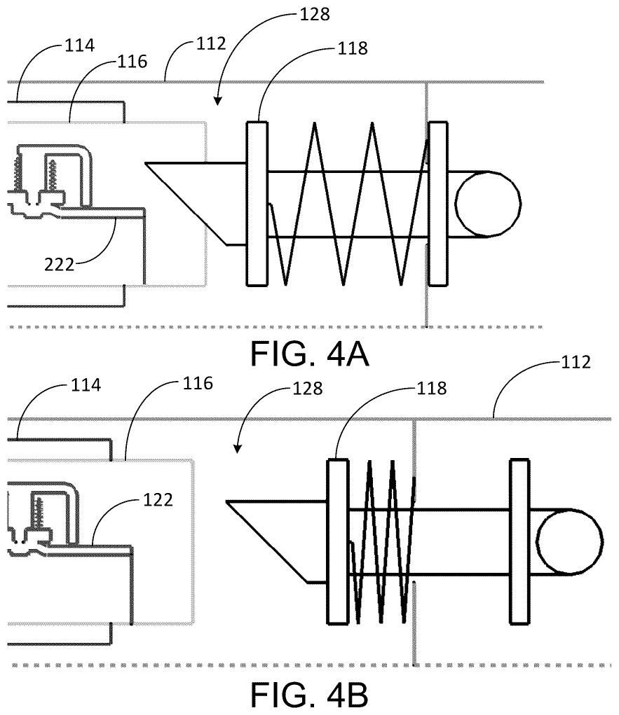

According to an exemplary embodiment, frame 112 may comprise an opening 128 configured to receive the support arm 106 in the closed position. According to an exemplary embodiment, the retention mechanism 118 may be configured to secure the support arm 106 in the closed position, as shown, e.g., in more detail, in FIGS. 3 and 4A-4B. According to an exemplary embodiment, when in a first position (as shown, e.g., in FIGS. 3 and 4A), the retention mechanism 118 may be configured to engage the support arm 106, causing the support arm 106 to be secured within the opening 128 of the frame 112 (i.e., maintaining the support arm 106 in a closed position). According to an exemplary embodiment, when in a second position (as shown, e.g., in FIG. 4B), the retention mechanism 118 may be configured to disengage the support arm 106, causing the support arm 106 to not be secured within the opening 128 of the frame 112 (i.e., freeing the support arm 106 to be able to rotate into an open position). The retention mechanism 118 may comprise a retention pin and spring and/or other suitable retention mechanism configured for securing the support arm 106.

According to an exemplary embodiment, the support arm 106 may be configured to rotate around the rotation/pivot axis pin 120 and/or other suitable rotation axis means. According to an exemplary embodiment, the support arm 106 may be configured to rotate 90 degrees from the closed position to the open position. It is noted, however, that other degrees of rotation of the support arm 106 may be incorporated while maintaining the spirit and functionality of the present disclosure.

According to an exemplary embodiment, when in the open position, the support arm 106 may be extended into an extended position. According to an exemplary embodiment, extending the support arm 106 into the extended position may comprise extending the inner support arm 116 in relation to the outer support arm 114.

According to an exemplary embodiment, the tailgate bed extension panel 104 may be configured to rotate about the one or more panel hinges 126, causing the tailgate bed extension panel 104 to rotate into the open position (as shown, e.g., in FIG. 1D, as opposed to the closed position as shown, e.g., in FIGS. 1A-1C).

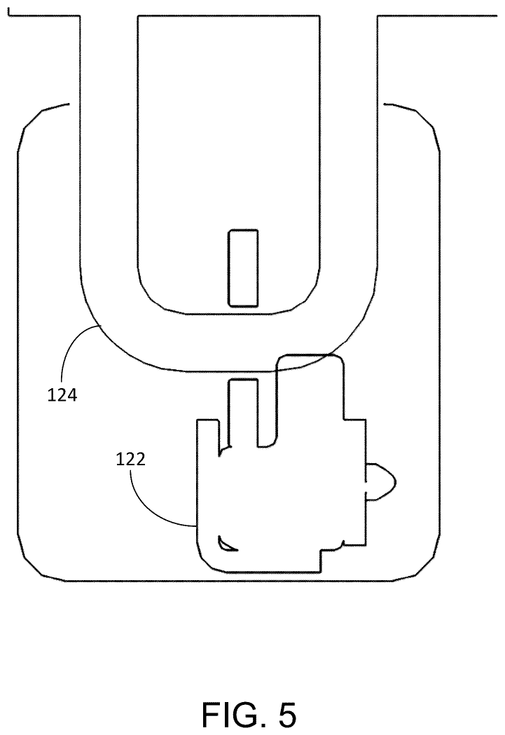

The latch assembly 122 may be coupled to and/or a component of the support arm 106. According to an exemplary embodiment, the tailgate bed extension panel 104 may comprise the striker 124 configured to be secured within the latch assembly 122 of the support arm 106 as shown, e.g., in FIG. 5, when the tailgate bed extension panel 104 is in the open position.

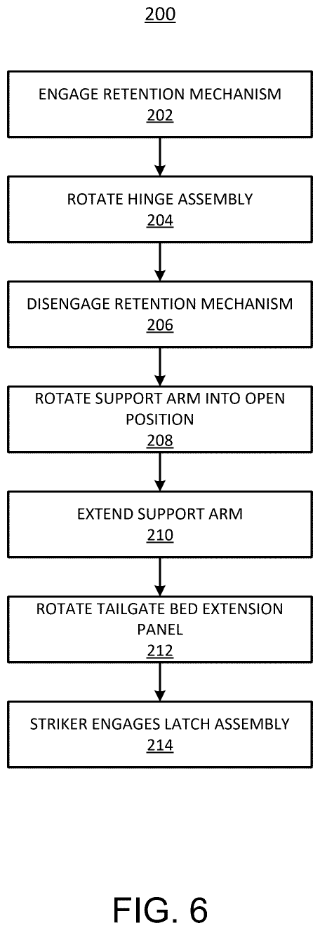

Referring now to FIG. 6, a flowchart of a method 200 for engaging a tailgate panel extension bed support arm is illustratively depicted, in accordance with an exemplary embodiment of the present disclosure.

At 202, a retention mechanism may engage a support arm in a closed position. At 204, a hinge assembly of a tailgate of a vehicle may be rotated, exposing a support arm.

At 206, the retention mechanism may be disengaged, enabling the support arm to rotate to an open position. At 208, the support arm may be rotated to the open position. According to an exemplary embodiment, the support arm may be configured to rotate 90 degrees from the closed position to the open position. It is noted, however, that other degrees of rotation may be incorporated while maintaining the spirit and functionality of the present disclosure.

According to an exemplary embodiment, at 210, the support arm may be extended into an extended position. According to an exemplary embodiment, the support arm may comprise an inner support arm and an outer support arm which are configured to move in relation to each other to enable the support arm to expand and contract. It is noted, however, that other means of expanding and/or contracting the support arm may be implemented while maintaining the spirit and functionality of the present disclosure.

At 212, a tailgate bed extension panel may be rotated about one or more hinges to an open position such that a striker of the tailgate bed extension panel may engage a latch assembly on the support arm. At 214, the striker may engage the latch assembly.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A tailgate extension system, comprising:
a tailgate coupled to a vehicle, the tailgate comprising:
i) a frame;
ii) a panel hinge assembly coupled to the frame;
iii) a tailgate bed extension panel, coupled to the panel hinge assembly, and configured to rotate about the panel hinge assembly along a first axis of rotation; and
iv) a support arm coupled to the frame and configured to rotate about the frame along a second axis of rotation.

2. The tailgate extension system of claim 1, wherein the support arm comprises an inner support arm and an outer support arm.

3. The tailgate extension system of claim 1, wherein the support arm is configured to extend into an extended position.

4. The tailgate extension system of claim 1, wherein:
i) the tailgate bed extension panel is configured to rotate between a closed position and an open position,
ii) the support arm is configured to rotate between a closed position and an open position, and
iii) when the tailgate bed extension panel is in the open position and the support arm is in the open position, the tailgate bed extension panel is configured to engage the support arm.

5. The tailgate extension system of claim 1, further comprising a retention mechanism configured to secure the support arm in the closed position.

6. The tailgate extension system of claim 5, wherein the retention mechanism comprises a retention pin and spring.

7. The tailgate extension system of claim 1, wherein the frame comprises an F-frame.

8. The tailgate extension system of claim 1, further comprising:
a striker coupled to the tailgate bed extension panel; and
a latch assembly coupled to the support arm.

9. The tailgate extension system of claim 8, wherein, when the tailgate bed extension panel engages the support arm, the striker is configured to engage the latch assembly.

10. The tailgate extension system of claim 1, wherein the frame comprises an opening configured to house the support arm when the support arm is in the closed position.

11. The tailgate extension system of claim 1, wherein the first axis of rotation is perpendicular to the second axis of rotation.

12. The tailgate extension system of claim 1, wherein the support arm is configured to rotate 90 degrees about the frame to rotate from the closed position to the open position.

13. The tailgate extension system of claim 1, further comprising the vehicle.

14. The tailgate extension system of claim 13, wherein the vehicle comprises a pickup truck.

15. A method for engaging a tailgate panel extension bed support arm, comprising:
a) disengaging a retention mechanism, wherein, when engaged, the retention mechanism is configured to secured a support arm of a tailgate in a closed position,
wherein the tailgate is coupled to a vehicle and comprises:
a frame;
a panel hinge assembly coupled to the frame;
a tailgate bed extension panel, coupled to the panel hinge assembly, and configured to rotate about the panel hinge assembly along a first axis of rotation; and
the support arm coupled to the frame and configured to rotate about the frame along a second axis of rotation;
b) rotating the support arm into the open position; and
c) rotating the tailgate bed extension panel to an open position, causing the tailgate bed extension panel to engage the support arm.

16. The method of claim 15, further comprising, prior to rotating the support arm into the open position, rotating the hinge assembly, exposing the support arm.

17. The method of claim 15, further comprising extending the support arm into an open position.

18. The method of claim 15 wherein i) the tailgate bed extension panel is configured to rotate between a closed position and an open position, ii) the support arm is configured to rotate between a closed position and an open position, and iii) when the tailgate bed extension panel is in the open position and the support arm is in the open position, the tailgate bed extension panel is configured to engage the support arm.

19. The method of claim 15, wherein the retention mechanism comprises a retention pin and spring.

20. The method of claim 15, wherein the tailgate further comprises:
a striker coupled to the tailgate bed extension panel; and
a latch assembly coupled to the support arm.
